(19) United States
(12) Patent Application Publication
(10) Pub. No.: US 2015/0115114 A1
(43) Pub. Date: Apr. 30, 2015

(54) WEAPON HOLDER FOR TREE STAND

(71) Applicant: Michael White, Moulton, AL (US)

(72) Inventor: Michael White, Moulton, AL (US)

(21) Appl. No.: 14/522,920

(22) Filed: Oct. 24, 2014

Related U.S. Application Data
(60) Provisional application No. 61/895,935, filed on Oct. 25, 2013.

(51) Int. Cl. A01M 31/02; F16B 2/06; F16B 7/04; F41A 23/18

(52) U.S. Cl. CPC A01M 31/02; F41A 23/18; F16B 2/06; F16B 7/04
USPC 248/201

(57) ABSTRACT

A weapon holder device is provided for releasably securing a variety of hunting weapons to a variety of tree stands. The device includes two weapon clamps made of an elastomeric material which secure a variety of hunting weapons on their longitudinal ends, and two brackets which rotatably attach the weapon clamps to two split-clamps. The split-clamps form a semi-permanent interference fit around a variety of tree stand frame members such that the weapon may be transported through rugged wilderness and during a hunter's ascent and descent of a tree, while maintaining hunter safety and protecting the weapon from damage.

The inventor, through this non-provisional patent application, claims priority based on prior provisional patent application Ser. No. 61/895,935.

### BACKGROUND OF THE INVENTION

This invention is directed to a device which holds a game hunter's weaponry attached to a hunting tree stand. Tree stands are devices which may be mounted to or supported in a tree from which a hunter hunts game. A variety of tree stands are available for sale, many of which include platforms, seats and other amenities such as climbing equipment and safety mechanisms. It has become customary for a hunter to carry his or her tree stand, hunting weapon (e.g., rifle, gun, or bow and arrows) and other equipment into the wilderness alone. The hunter then attaches the tree stand to the tree and uses the tree stand to climb the tree. The hunter typically hunts alone from the tree stand.

Transporting and setting up hunting equipment may be very cumbersome for the lone hunter given the size and amount of equipment. The cumbersome nature may lead to increased safety risks and potential injury to the hunter's person and valuable weaponry. In particular, transportation of weaponry to and from the hunting location, and transportation of weaponry as the hunter ascends and descends a tree has proven troublesome and dangerous for hunters. The hunter may drop his or her weapons and damage them. The hunter may become fatigued while climbing a tree with the weapon strapped to his or her body, or the hunter may suffer serious injury while trying to lift a weapon from the ground into a tree stand with a rope or similar device. In addition, hunters have experienced difficulty accessing their weapons in a safe, quick and quiet manner while in a tree stand; a manner which allows the hunter to shift from a resting position to a firing without startling his or her prey.

Some inventors have proposed solutions to weaponry transportation and access issues but have not been successful. Some tree stands have provided for gun holders. Other inventions include gun holders which might attach to different tree stands. However, no devices exist which provide for a durable weapon holder which may be semi-permanently secured to different tree stands and used to safely transport a variety of weapons through the wilderness, safely attach weapons to the tree stand while the hunter ascends and descends the tree, and which allows the hunter quick and silent access to the weapon. This device provides all the foregoing benefits while protecting various weapons from damage during transport.

### BRIEF SUMMARY OF THE INVENTION

There are two primary embodiments of the invention. Each embodiment comprises two split-clamps, preferably made of a lightweight, durable and weather-resistant metal. Each of the split-clamps attaches to the outer bar frame member of a free stand via an interference fit. In the first embodiment, the split-clamps combine to create an interference fit around an outer bar frame member with a square cross-section. In the second embodiment, the split-clamps combine to create an interference fit around the outer bar frame member with a circular cross-section.

Each embodiment comprises two L-shaped brackets, preferably made of identical material as the split-clamps, each of which is rotatably attached to the exterior of a split-clamp perpendicular to the tree stand outer safety bar frame member. Each L-shaped bracket may rotate 360 degrees parallel to the longitudinal axis of the outer bar frame member, thus allowing for fitment of multiple weapons of different lengths. Each embodiment comprises a weapon clamp with means of attaching a hunting weapon such as a gun, rifle or bow and arrows to each L-shaped bracket simultaneously by means of a durable elastomeric material such as natural or synthetic rubber.

Various other features, advantages and characteristics will become apparent after reading the following specification.

### BRIEF DESCRIPTION OF THE DRAWINGS

The preferred embodiments of the present invention are set forth in the figures, like items bearing like reference numerals and in which:

FIG. 1. FIG. 1 shows an isometric front view of a first embodiment of the weapon holder;

FIG. 2. FIG. 2 is a magnified view of the first embodiment;

FIG. 3. FIG. 3 is an exploded perspective view showing the details of the components in the first embodiment;

FIG. 4. FIG. 4 shows an isometric front view of a second embodiment of the invention.

### DETAILED DESCRIPTION AND BEST MODE OF IMPLEMENTATION

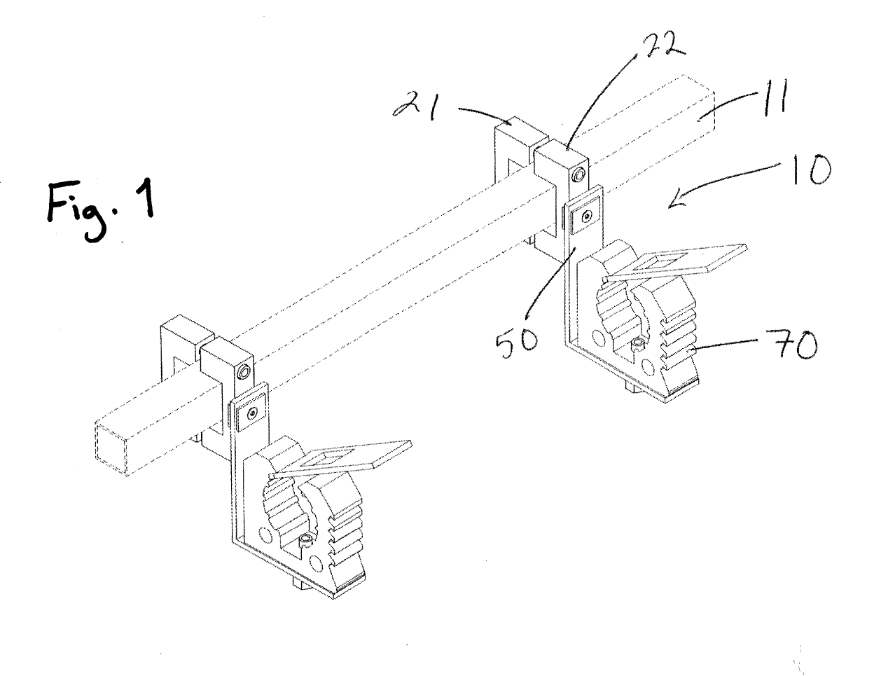

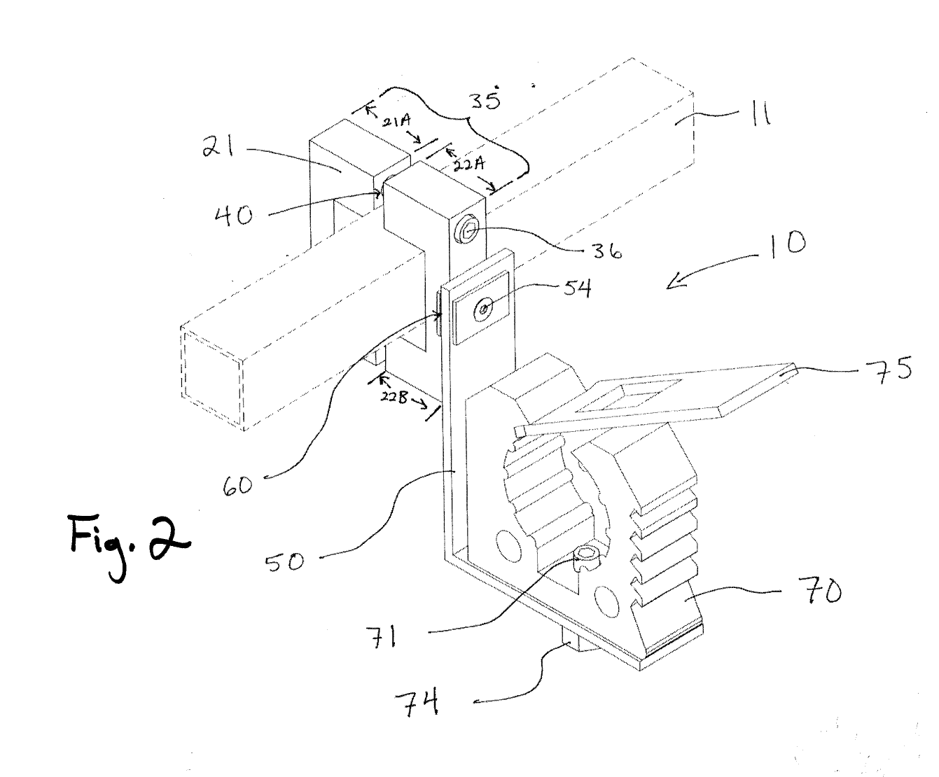

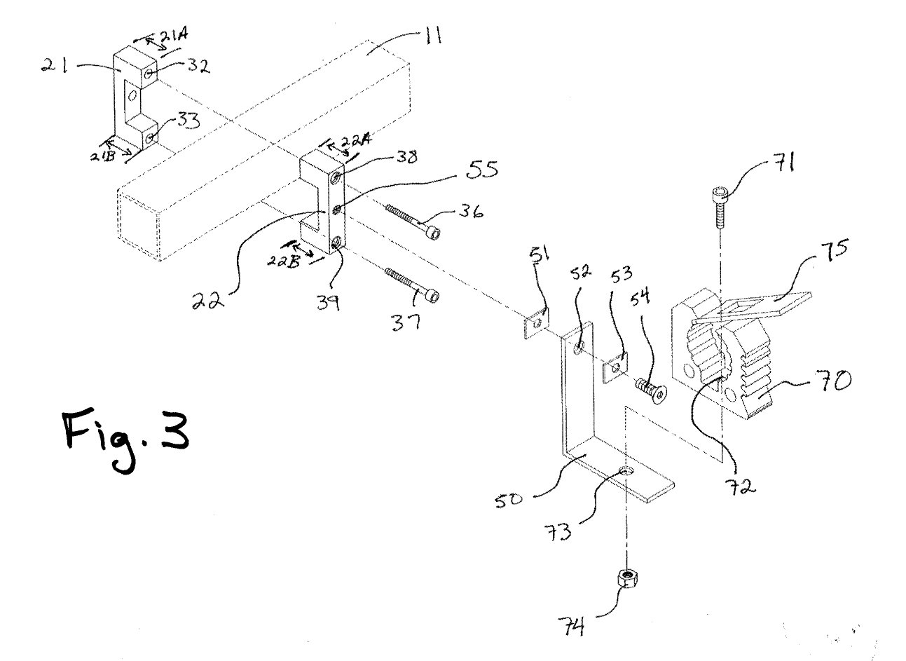

A first preferred embodiment of the weapon holder is shown in FIGS. 1-3 generally at 10. Weapon holder 10 comprises a first member or rear split-clamp half 21 with tapped apertures 32 and 33 (FIG. 3). Weapon holder incorporates interference fit means 35 to attach it to tree stand outer safety bar frame member 11 (FIG. 2). Interference fit means 35 in this embodiment includes front split-clamp half 22 which clamps weapon holder to tree stand frame member 11 by compressing tree stand frame member 11 between front split-clamp half 22 and rear split-clamp half 21. Front split-claim half 22 clamps tree stand frame member 11 using bolts 36 and 37, which are inserted through apertures 38 and 39 of front split-clamp half 22 such that bolts 36 and 37 may then screw into tapped apertures 32 and 33 of rear split-clamp half 21 (FIG. 3). Apertures 38 and 39 of front split-clamp 22 should be partially bored such that the heads of bolts 36 and 37 will be flush or counter-sunk beyond the outer edge of front split-clamp half 22 when the bolts are tightened (FIG. 2). The lengths of laterally extending sections 21A and 21B of rear split-clamp half 21, and laterally extending sections 22A and 22B of front split-clamp half 22 should be at the appropriate length such that an approximately one-eighth inch (⅛″) space 40 remains between split-clamp halves 21 and 22 when bolts 36 and 37 are screwed tightly into tapped apertures 38, 32, 39 and 33. The split-clamp halves should be equal size and may equivalently vary in overall size to accommodate various sizes of frame member 11. It is possible to use other clamping means to create the same interference fit; however, this means is rather simple and reliable. This clamping means may reliably and immovably attach numerous objects to a tree stand frame member. The materials used to form split-clamps 21 and 22 should be a high-strength, weather-resistant, durable and lightweight material, preferably a metal. Aluminum has proven to be a cost-effective metal to achieve the desired performance, although other materials may be used.

Weapon holder 10 comprises a second member or L-shaped bracket 50 which attaches to front split-clamp half 22 by means 60. Means 60 comprises snugly fitting screw 54 through washer 53 and aperture 52 of L-shaped bracket 50, and then through washer 51, and then screwing screw 54 into tapped aperture 55 of front split-clamp half 22 (FIG. 3). Aperture 52 of L-shaped bracket 50 should be partially bored such that the head of screw 54 will be flush or counter-sunk into the outer edge of L-shaped bracket 50 when screw 54 is tightened (FIG. 2). Attachment means 60 allows for 360 degree rotational movement of L-shaped bracket 50 around the axis created by screw 54 which runs perpendicular to frame member 11 without loosening attachment means 60 or screw 54. While a variety of materials may be suitable for L-shaped bracket 50, it may often be preferred for material compatibility reasons to use the same material as used for front split-clamp half 22.

Weapon holder 10 comprises a third member or weapon clamp 70 which is used to secure a variety of hunting weapons while attached to tree stand frame member 11 (FIG. 2). Weapon clamp 70 attaches to L-shaped bracket 50 by inserting bolt 71 through aperture 72 in weapon clamp 70, through aperture 73 in L-shaped bracket 50 and screwing nut 74 onto bolt 71 such that the back of weapon clamp 70 almost abuts the vertical portion of L-shaped bracket 50 (FIG. 3). Weapon clamp 70 includes strap 75 which extends from the back of weapon clamp 70 over the top of weapon clamp 70 and releasably attaches to the outside of weapon clamp 70 such that it will hold a weapon in place during movement of the invention while it is attached to tree stand frame member 11 (FIG. 3). Various means of releasably attaching strap 75 to weapon clamp 70 may be used; however, insertion of one or more tabs on the outside of weapon clamp 70 through one or more holes in strap 75 has proven effective (FIG. 3). Weapon clamp 70 should be sufficiently robust and sizeable to secure the either longitudinal end of a hunting weapon such as a rifle (i.e., the stock or barrel), shot gun, or bow and arrows. It is preferred that weapon clamp 70 be made from an elastomeric material such as rubber which is durable, weather-resistant, and will not mar, deface or otherwise harm the weapon while it is secured in the clamp. Such an elastomeric material will also allow the hunter to quickly and silently release the weapon so as not to spook his or her prey.

In operation, weapon clamp 70 is attached to L-shaped bracket 50 by bolt 71 and nut 74. The elastomeric properties of weapon clamp 70 should be sufficient to prevent bolt 71 from “backing off” or unscrewing itself from nut 74. L-shaped bracket 50 is attached to the outside of front split-clamp 22 by screwing screw 54 into tapped aperture 55 of front split-clamp half 22. The device is clamped to tree stand frame member 11 by positioning split-clamp halves 21 and 22 on either side of frame member 11 and screwing bolts 36 and 37 through apertures 38 and 39 of front split-clamp 22 and into tapped apertures 32 and 33 of rear split-clamp 21 until bolts 36 and 37 are tight enough to create an interference fit around frame member 11. The interference fit around frame member 11 will secure the invention to tree stand frame member 11 until bolts 36 and 37 are unscrewed, thereby allowing the hunter to secure his or her weapon to the tree stand during transport through the wilderness and during ascent and descent of a tree while on the tree stand. The size of weapon clamps 70 and rotational movement of L-shaped brackets 50 will allow the hunter to safely and conveniently secure various types and sizes of hunting weapons to the tree stand.

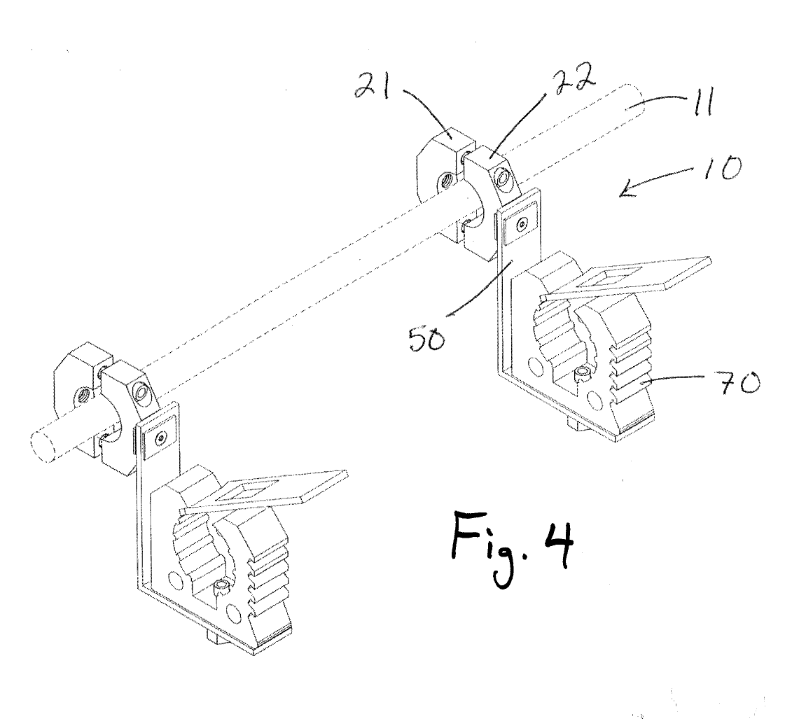

A second embodiment of the invention is shown in FIG. 4 generally at 10. In the second embodiment, split-clamps 21 and 22 include tapped apertures 32, 33, 38, 39, and 55 as in the first embodiment. The split clamps clamp the invention to a cylindrical tree stand frame member by the same sequence of means described above regarding the first embodiment. The radii of the inside faces of the split-clamps should be such that they fit snugly around the tree stand frame member and leave an approximately one-eighth inch (⅛″) space between the split-clamp halves when bolts 36 and 37 are screwed tightly into tapped apertures 38, 39, 32 and 33 as in the first embodiment. This second embodiment should attach to the tree stand and operate in the same manner as the first embodiment, the only difference being the interior shape of the split-clamps which are adapted to clamp the device to a cylindrical tree stand frame member.

Various changes, alternatives and modifications will become apparent after a reading of the foregoing specification. It is intended that all such changes, alternatives and modifications which fall within the scope of the appended claims be considered part of the invention.

I claim:

1. A weapon holder for use with a tree stand which secures the weapon to the tree stand while a person climbs a tree with the tree stand, comprising any feature described, either individually or in combination with any feature, or in any configuration as follows:
a.) a first weapon clamp with means for receiving a first portion of the weapon and holding the weapon securely to the tree stand so the weapon will not move within the clamp or fall out of the clamp while the tree stand is in motion;
b.) a first removable means for attaching said first weapon clamp to a first frame portion of said tree stand, comprised of a first split-clamp which fits around said first frame portion of the tree stand;
c.) a second weapon clamp with means for receiving a second portion of the weapon and holding the weapon securely to the tree stand so the weapon will not move within the clamp or fall out of the clamp while tree stand is in motion;
d.) a second removable means for attaching said second weapon clamp to a second frame portion of said tree stand, comprised of a second split-clamp which fits around said second frame portion of the tree stand, said second attachment means being separate from said first attachment means;
e.) a rotatable and removable attachment means for attaching each of said first and second weapon clamps to each of said first and second split-clamp members, respectably.
whereby said first and second weapon clamps holding first and second portions of the weapon to maintain the weapon in a generally horizontal position to facilitate safety while the weapon is secured, to ensure the weapon does not drop to the ground while it is clamped to the tree stand, to protect the weapon against damage while the person climbs the tree within the tree stand, and to facilitate ease in the weapon being brought to a firing position.

2. The weapon holder of claim 1 wherein the first and second weapon clamps are comprised of an elastomeric, high-durability material.

3. The weapon holder of claim 2 wherein said elastomeric, high-durability material is rubber.

4. The weapon holder of claim 1 wherein each of said first and second weapon clamps includes a strap comprised of elastomeric, high-durability material which may be stretched over the weapon when the weapon is placed within said first and second weapon clamps.

5. The weapon holder of claim 4 wherein each of said straps releasably attaches to said first and second weapon clamps when the straps are stretched over the weapon to secure both first and second portions of the weapon in place.

6. The weapon holder of claim 1 wherein said first and second removable means of attaching each of said first and second weapon clamps to each of said first and second split-clamp members is further comprised of:
a) a first bracket which is removably attached to said first weapon clamp and said first split-clamp;
b) a second bracket which is removably attached to said second weapon clamp and said second split-clamp

7. The weapon holder of claim 6 wherein said first and second brackets are L-shaped.

8. The weapon holder of claim 6 wherein said first and second brackets are attached to said first and second weapon clamps with screws or bolts, whereby said screws or bolts may be removed to allow replacement of said weapon clamps.

9. The weapon holder of claim 6 wherein said means of attaching each of said first and second brackets to each of said first and second split-clamps is comprised of screws or bolts.

10. The weapon holder of claim 6 wherein said means of attaching each of said first and second brackets to each of said first and second split-clamps allows for 360 degree rotational movement of each of said brackets, which will allow for use with weapons of varying, non-uniform shapes and sizes.

11. The weapon holder of claim 1 wherein said first and second split-clamps attach to said first and second tree stand portions via interference fit means, thereby applying a compression force on said first and second tree stand portions which will prevent rotation of said first and second split-clamps around the axes created by said first and second tree stand portions.

12. The weapon holder of claim 11 wherein said interference means of applying the first and second split-clamps is effectuated by screws or bolts extended through each of the respective split-clamps, thereby rendering the split-clamps removable from each of said first and second tree stand portions.

13. The weapon holder of claim 1 wherein said first and second split-clamps are comprised of a high-durability material.

14. The weapon holder of claim 14 wherein said high-durability material is aluminum or aluminum alloy.
